(19) United States
(12) Patent Application Publication
(10) Pub. No.: US 2019/0318443 A1
(43) Pub. Date: Oct. 17, 2019

(54) SYSTEM AND METHOD OF OPERATING A TRANSPORTATION SERVICE TO PROVIDE REBATE RIDING

(71) Applicant: GM Global Technology Operations LLC, Detroit, MI (US)

(72) Inventors: Claudia V. Goldman-Shenhar, Mevasseret Zion (IL); Marco J. Gatti, Grosse Ile, MI (US); Gila Kamhi, Zichron Yaakov (IL)

(73) Assignee: GM Global Technology Operations LLC, Detroit, MI (US)

(21) Appl. No.: 15/953,997

(22) Filed: Apr. 16, 2018

(51) Int. Cl. G06Q 50/30; G06Q 20/08; G06Q 30/02; G06Q 50/00

(52) U.S. Cl. CPC G06Q 50/30; G06Q 20/0855; G06Q 30/0224; G06Q 50/01; G06Q 30/0239

(57) ABSTRACT

A method of operating a transportation service includes calculating a trip route for a trip request from a commuter, and transmitting a pick-up instruction to a transporting vehicle. A ride rebate option is communicated to the commuter, who may opt to execute it. The ride rebate option may include an option to purchase goods from a third-party provider, provide data to the third-party provider, complete a survey, or promote the third-party provider on social media. The third-party provider is notified when the commuter opts to execute the ride rebate option. Upon confirmation by the third-party provider that the commuter has executed the ride rebate option, a payment amount is transferred from the third-party provider to the transportation service. A fee charged to the commuter by the transportation service is reduced by the payment amount transferred to the transportation service from the third-party provider.

The disclosure generally relates to a system and a method of operating a transportation service.

Transportation services, such as a taxi cab service, a fleet service using autonomous and/or non-autonomous vehicles, trains, ferry boats, etc., provide transportation for a commuter from a current location to a destination selected by the commuter. The transportation service will charge a fee to the commuter, typically based on the duration and/or distance of the trip.

### SUMMARY

A method of operating a transportation service is provided. The method includes receiving a trip request with a central computing device at a service control location of the transportation service. The trip request is received from a commuter requesting transportation from a current location to a destination. The central computing device then calculates a trip route between the current location and the destination, and transmits a pick-up instruction to a transporting vehicle. The pick-up instruction includes the trip route. A mobile computing device of the transporting vehicle receives the pick-up instruction from the central computing device. The central computing device further communicates a ride rebate option to the commuter. The commuter may opt to execute the ride rebate option. The central computing device notifies a third-party provider when the commuter opts to execute the ride rebate option. Upon confirmation by the third-party provider that the commuter has executed the ride rebate option, a payment amount is transferred from the third-party provider to the transportation service. The central computing device reduces a fee that is charged to the commuter by the transportation service by the payment amount transferred to the transportation service from the third-party provider.

In one aspect of the method of operating the transportation service, the ride rebate option includes one of an option to purchase a product from the third-party provider, either via an online purchase or by making a detour from the original trip route to the third-party provider, an option to provide data to the third-party provider, or an option to promote the third-party provider on a social media platform. The option to provide data to the third-party provider may include, for example, the commuter providing details about the commuter's destination and travel habits to the third-party provider.

In another aspect of the method of operating the transportation service, the central computing device identifies the third-party provider, based on a distance between the third-party provider and the trip route. The central computing device may identify several different third-party providers that are located along or near to the trip route. The central computing device may then select the ride rebate option based on one or more of the identified third-party providers. IN other embodiments, the central computing device may select the third-party provider based on choices of other commuters. For example, the central computing device may select the third-party provider by analyzing social data of other persons, and present the commuter information about what other persons are doing or have been doing during similar days, times, and/or areas.

In another aspect of the method of operating the transportation service, the central computing device selects the ride rebate option to be communicated to the commuter. The central computing device may select the ride rebate option based on the trip route, or a user profile of the commuter stored in a memory of the central computing device. The user profile of the commuter may include, for example, one or more previous ride rebate options previously executed by the commuter, one or more previous destinations previously selected by the commuter, or one or more personal preferences identified by the commuter. The central computing device may continuously update the user profile of the commuter, based on each trip request, each ride rebate option selected, or personal preferences noted by the commuter. By so doing, the central computing device may select the best ride rebate option to entice the commuter to opt to execute the ride rebate option.

In one embodiment of the method of operating the transportation service, a personal characteristic of the commuter is sensed using a sensing device of the transporting vehicle. The mobile computing device of the transporting vehicle communicates the sensed personal characteristic of the commuter to the central computing device. The central computing device may then select the ride rebate based on the sensed personal characteristic of the commuter.

In another embodiment of the method of operating the transportation service, an environmental characteristic adjacent the transporting vehicle and along the travel route is sensed with a sensing device of the transporting vehicle. The mobile computing device of the transporting vehicle communicates the sensed environmental characteristic adjacent the transporting vehicle to the central computing device. The central computing device may then select the ride rebate based on the sensed environmental characteristic adjacent the transporting vehicle.

In another embodiment of the method of operating the transportation service, selecting the ride rebate option may include communicating social data to the commuter. The social data may include, but is not limited to, a destination of other persons along the trip route, current traffic congestion along the trip route, or a current public event along the trip route. The central computing device may select the ride rebate option based upon feedback from the commuter in response to the social data communicated to the commuter.

In one aspect of the method of operating the transportation service, the payment amount is dependent upon the ride rebate option executed by the commuter. For example, different ride rebate options may provide a different payment amount.

In one exemplary embodiment of the method of operating the transportation service, the ride rebate option is communicated to the commuter through an input/output device of the mobile computing device, such as but not limited to a touch screen display. In another embodiment, the ride rebate option may be communicated to the commuter through a personal handheld device of the commuter, such as but not limited to a mobile telephone, tablet, laptop computer, etc.

A system for a transportation service is also provided. The system includes a central computing device that is located at a service control location. The central computing device includes a processor, and a memory having a ride rebate algorithm stored thereon. The processor of the central computing device is operable to execute the ride rebate algorithm to implement a method of operating the transportation service. Particularly, the processor is operable to execute the ride rebate option to receive a trip request from a commuter, requesting transportation from a current location to a destination. The ride rebate algorithm then calculates a trip route between the current location and the destination, and transmits a pick-up instruction to a transporting vehicle. The pick-up instruction includes the trip route. The ride rebate algorithm further communicates a ride rebate option to the commuter. The commuter may opt to execute the ride rebate option in order to reduce a fee for the trip between the commuter's current location and the destination. The ride rebate algorithm notifies a third-party provider when the commuter has opted to execute the ride rebate option, and receives an electronic payment amount from the third-party provider upon confirmation from the third-party provider that the commuter has executed the ride rebate option. The fee charged to the commuter by the transportation service is then reduced by the payment amount received from the third-party provider, in exchange for the commuter executing the ride rebate option.

In one aspect of the system, the transporting vehicle includes a mobile computing device including a processor, and a memory having the ride rebate algorithm stored thereon. The processor of the mobile computing device is operable to execute the ride rebate algorithm to receive the pick-up instruction from the central computing device, and transport the commuter from the current location of the commuter to the destination.

In another aspect of the system for the transportation service, the central computing device is operable to execute the ride rebate algorithm to select the ride rebate option for the commuter. The ride rebate option may be selected based on a distance between the trip route and the third-party provider, a user profile of the commuter, a personal characteristic of the commuter, or an environmental characteristic adjacent the transporting vehicle along the trip route.

Accordingly, the system and method provided herein enable the commuter to reduce the fee charged by the transportation service, by executing the ride rebate option. The ride rebate option may be embodied in many different options, such as prompting the commuter to purchase a product from the third-party provider, prompting the commuter to change their destination to the third-party provider, prompting the commuter to provide data feedback to the third-party provider, such as but not limited to completing a survey, or providing information of the commuter's travel habits, personal preferences, etc. Additionally, the ride rebate option may include prompting the commuter to promote the third-party provider on a social medial platform. By enticing the commuter to interact with the third-party provider, the third-party provider is receiving a commercial benefit, for which the third-party provider may compensate the transportation service by the payment amount. The transportation service may then reduce the fee charged to the commuter by the payment amount. Accordingly, by opting to execute the ride rebate option, the commuter may receive a reduced fee or no fee ride.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic aerial representation of a system for a transportation service for transporting a commuter from a current location to a destination.

FIG. 2 is a schematic plan view of an input/output device of a mobile computing device in a transporting vehicle of the transportation system.

FIG. 3 is a schematic plan view of a map showing social data relative to a trip route.

FIG. 4 is a flowchart representing a method of operating the transportation service.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

Referring to the FIGS., wherein like numerals indicate like parts throughout the several views, a system for a transportation service is generally shown at 20. While the transportation service is described herein embodied as an automotive transportation service, it should be appreciated that the teachings of this disclosure may be applied to other modes of transportation, such as railway transportation, air transportation, water transportation, etc.

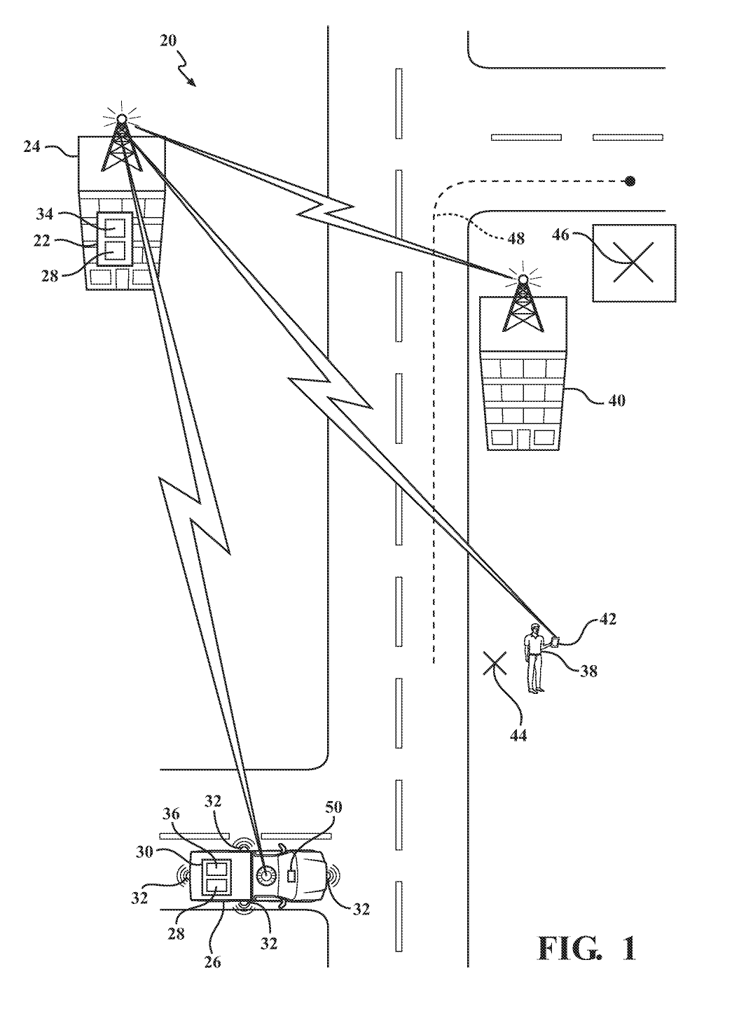

Referring to FIG. 1, the system 20 includes a central computing device 22 located at a service control location 24, and a transporting vehicle 26. The central computing device 22 may include a computer and/or processor, and include all software, hardware, memory, algorithms, connections, sensors 32, transmitters, receivers, etc., for managing and controlling the operation of the ride rebate system 20. As such, a method of operating the transportation system 20, which is described in greater detail below, may be embodied as a program or algorithm operable on the central computing device 22. It should be appreciated that the central computing device 22 may include a device capable of executing the required tasks to control the operation of the transportation system 20.

The central computing device 22 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics.

The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

The central computing device 22 includes tangible, non-transitory memory on which are recorded computer-executable instructions, including a ride share algorithm 28. The processor of the central computing device 22 is operable to execute the ride share algorithm 28. The ride share algorithm 28 implements the method of controlling the transportation system 20.

The transporting vehicle 26 may include any type or form of moveable platform. For example, the transporting vehicle 26 may include a car, a van, a truck, a train, a plane, a boat, a bus, etc. The transporting vehicle 26 may include an autonomous vehicle, a semi-autonomous vehicle, or a non-autonomous vehicle. The transporting vehicle 26 includes a mobile computing device 30. The mobile computing device 30 may include a computer and/or processor, and include software, hardware, memory, algorithms, connections, sensors 32, transmitters, receivers, etc., for managing and controlling the operation of the transporting vehicle 26. As such, the method of operating the transportation system 20, which is described in greater detail below, may be embodied as a program or algorithm at least partially operable on the mobile computing device 30. It should be appreciated that the mobile computing device 30 may include a device capable of executing the required tasks to control the operation of the transporting vehicle 26.

The mobile computing device 30 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and required input/output (I/O) circuitry, I/O devices, and communication interfaces, as well as signal conditioning and buffer electronics.

The computer-readable memory may include non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

The mobile computing device 30 includes tangible, non-transitory memory on which are recorded computer-executable instructions, including all or a portion of the ride share algorithm 28. The processor of the mobile computing device 30 is operable to execute all or portions of the ride share algorithm 28. While the exemplary embodiment of the method of operating the transportation system 20 is described below with reference to either the central computing device 22 or the mobile computing device 30 performing certain tasks, it should be appreciated that the execution of the various steps of the method may be executed by either of the central computing device 22 or the mobile computing device 30. As such, the central computing device 22 and the mobile computing device 30 may be linked or networked together so that they operate as a single computing device to execute the steps of the method described herein.

In addition to the mobile computing device 30, the transporting vehicle 26 may include one or more sensors 32 that are linked to and in communication with the mobile computing device 30. The sensors 32 of the transporting vehicle 26 may include one or more cameras, temperature sensors 32, moisture sensors 32, barometric pressure sensors 32, etc. In addition, the mobile computing device 30 and/or the central computing device 22 may include software, such as image recognition software 34 and/or weather condition determination software 36 that use data from the different sensors 32 of the transporting vehicle 26 to discern conditions and/or characteristics of a commuter 38 or environmental conditions around the transporting vehicle 26.

As noted above, the ride share algorithm 28 implements the method of operating the transportation service. The method of operating the transportation service enables the commuter 38 to offset part or all of the cost of a trip by executing a ride share option. The ride share option provides a commercial benefit to a third-party provider 40. In exchange for this commercial benefit, the third-party provider 40 may remit a payment amount to the transportation service, which may then be applied to discount the cost of the commuter's trip by all or a portion of the payment amount received from the third-party provider 40. As such, it is contemplated that the transportation service may enter into agreements with many different third-party providers 40. While only a single third-party provider 40 is described herein, it should be appreciated that the teachings of this disclosure may be applied to many different third-party providers 40 that choose to participate in the ride share program of the transportation service.

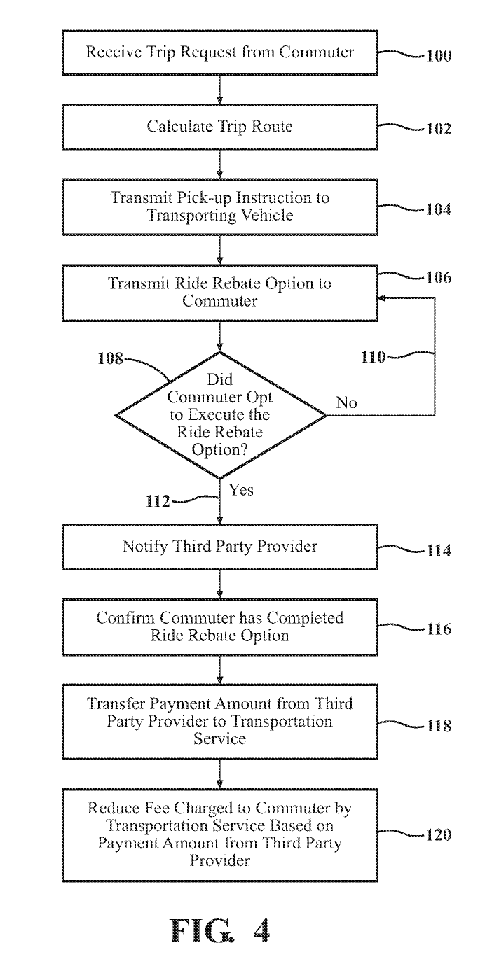

Referring to FIG. 4, the method includes receiving a trip request from a commuter 38. The step of receiving the trip request from the commuter is generally indicated by box 100 in FIG. 4. The trip request is ultimately received by the central computing device 22. The trip request may be sent and received in a suitable manner. For example, the trip request may be sent and received electronically by the commuter 38 using a personal handheld device 42 or a computer electronically connected to the central computing device 22. In other embodiments, the trip request may be made via a phone call to an operator logged onto the central computing device 22, whereby the operator enters the trip request into the central computing device 22. It should be appreciated that the trip request may be sent by the commuter 38 and received by the central computing device 22 in some other manner not specifically described herein. The trip request includes a current location 44 of the commuter 38, and a desired destination 46 for the trip.

Once the central computing device 22 has received the trip request, the central computing device 22 then calculates a trip route 48 between the current location 44 of the commuter 38 and the destination 46. The step of calculating the trip route is generally indicated by box 102 in FIG. 4. The central computing device 22 may calculate the trip route 48 in a suitable manner, considering one or more different factors. For example, the central computing device 22 may consider the route providing the shortest distance between the current location 44 of the commuter 38 and the destination 46, as well as the route having the quickest travel time. Other factors may be considered, such as traffic patterns, time of day, weather, road construction, etc. The specific manner in which the central computing device 22 calculates the trip route 48 is not pertinent to the teachings of this disclosure, are understood by those skilled in the art, and are therefore not described in detail herein.

Once the trip route 48 has been calculated, the central computing device 22 transmits a pick-up instruction to the transporting vehicle 26. The step of transmitting the pick-up instruction is generally indicated by box 104 in FIG. 4. The pick-up instruction includes the trip route 48. It is contemplated that the transporting vehicle 26 may include an autonomous vehicle, in which the transporting vehicle 26 is operated by the mobile computing device 30 of the transporting vehicle 26. In other embodiments, the transporting vehicle 26 may include a non-autonomous vehicle, in which the transporting vehicle 26 is operated by a driver. Upon the mobile computing device 30 of the transporting vehicle 26 receiving the pick-up instruction from the central computing device 22, the transporting vehicle 26 travels to the current location 44 of the commuter 38 for pick-up.

In addition to transmitting the pick-up instructions to the transporting vehicle 26, the central computing device 22 further transmits a ride rebate option to the commuter 38. The ride rebase option may be transmitted to the commuter 38 at any time during their trip. Furthermore, the ride rebate option does not have to be communicated as part of a specific trip. For example, in other embodiments, the ride rebate option may be communicated to the commuter 38 at any time, and credit provided to the commuter 38 for future trips. The step of transmitting the ride rebate option to the commuter is generally indicated by box 106 in FIG. 4. The ride rebate option may be transmitted to the commuter 38 via an input/output device 50 of the mobile computing device 30 of the transporting vehicle 26, through the personal handheld device 42 of the commuter 38, or through some other process not described herein. The ride rebate option enables the commuter 38 to choose to participate in an activity that provides a commercial benefit to the third-party provider 40, for which the third-party provider 40 is willing to compensate the commuter 38 and the transportation service for.

The central computing device 22 selects the ride rebate option to communicate to the commuter 38. The ride rebate option may be selected in a suitable manner that considers different factors. Additionally, the ride rebate option may include different forms, and/or require different actions for the commuter 38 to execute. For example, the ride rebate option may be selected based on a distance between the third-party provider 40 and the trip route 48. As noted above, the transportation service may enter into agreements with several different third-party providers 40. As such, the central computing device 22 may identify a specific third part provider and select an appropriate ride rebate option for the specific third-party provider 40. The central computing device 22 may select the third-party provider 40 based on a distance between the third-party provider 40 and the trip route 48. In other embodiments, the central computing device 22 may select multiple third-party providers 40 that are located within a pre-determined distance of the trip route 48, and present the selected third-party providers 40 to the commuter 38 as a list to choose from. It is contemplated that for some commuters 38 and/or trip routes 48, the central computing device 22 may not identify a sutiable third-party provider 40. Upon selecting at least one of the third-party providers 40 from the list, the central computing device 22 selects and communicates an appropriate ride rebate option for the selected third-party provider 40.

The third-party provider 40 may include, for example, a business located near the travel route. The ride rebate option that is communicated to the commuter 38 may take several different forms. For example, the ride rebate option may be presented to the commuter 38 as an opportunity to purchase a product from the third-party provider 40. In another embodiment, the ride rebate option may be presented to the commuter 38 as an opportunity to revise the trip route 48 to include a stop at the third-party provider 40. In another embodiment, the ride rebate option may be presented to the commuter 38 as an opportunity to complete a survey related to the third-party provider 40 or otherwise provide some form of data to the third-party provider 40. In yet another embodiment, the ride rebate option may be presented to the commuter 38 as an option to promote the third-party provider 40 on a social media platform. It should be appreciated that the ride rebate option may be presented to the commuter 38 in a form that provides some commercial benefit to the third-party provider 40 for which the third-party provider 40 is willing to provide compensation, and that the form in which the ride rebate option is presented to the commuter 38 may differ from the exemplary embodiments described herein. Additionally, the requirements for the commuter 38 for completing or executing the ride rebate options will depend upon the form of the ride rebate option, and may vary from the exemplary embodiments described herein.

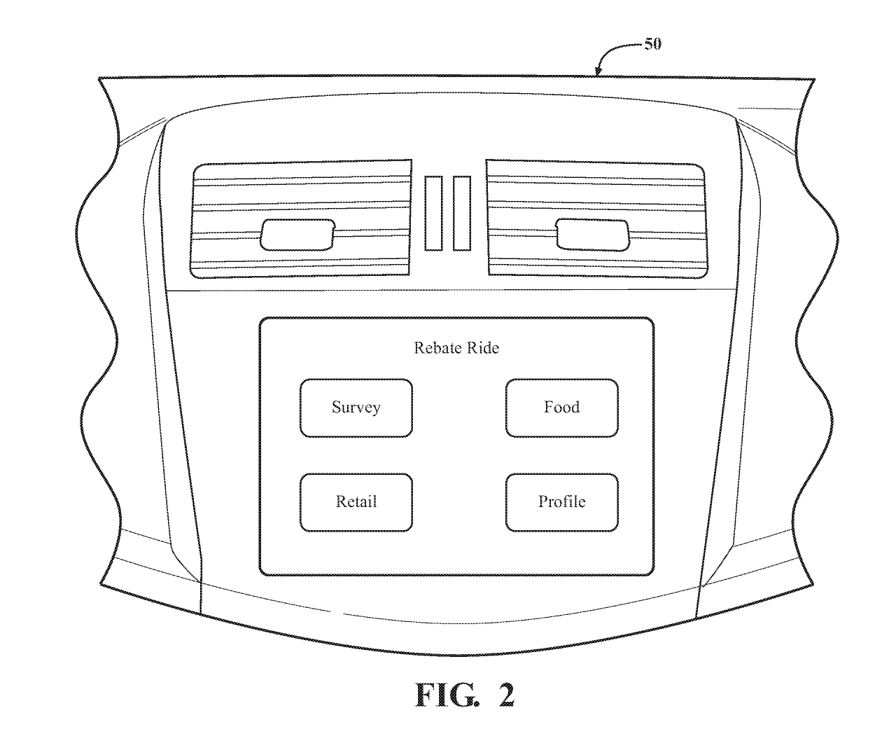

The third-party provider 40 identified by the central computing device 22 and the ride rebate option selected by the central computing device 22 may be based upon input from the commuter 38 and/or personal characteristics of the commuter 38 obtained via sensors 32 of the transporting vehicle 26 and/or environmental characteristics adjacent the transporting vehicle 26 during the trip. For example, referring to FIG. 2, a computing application may present different option categories to the commuter 38, such as but not limited to “Survey”, “Food”, “Retail”, “Profile”, etc. The commuter 38 may then select which category, if any, that the commuter 38 may have an interest in. Based upon the commuter's 38 selected category, the central computing device 22 may then identify an appropriate third-party provider 40 along or near the trip route 48, and an appropriate ride rebate option for that category and specific third-party provider 40. For example, the commuter 38 may select the category “Food”, to which the central computing device 22 may identify one or more restaurants along the trip route 48. The commuter 38 may then select a restaurant, and either place an order or request that the trip route 48 be revised to include a stop at that particular restaurant. Upon the commuter 38 completing a purchase at the selected restaurant, the restaurant may transfer a pre-arranged payment amount to the transportation service provider, which may in turn reduce the fee charged to the commuter 38. Accordingly, by dining at that restaurant, the commuter 38 may collect points for each dollar spent at the restaurant. Those points may be applied toward paying for future rider fees.

In another embodiment, sensors 32 on the transporting vehicle 26 may capture data related to the commuter 38 and the environmental conditions outside the transporting vehicle 26 during the trip, and transmit this data to the central computing device 22. The central computing device 22 may use this data to select ride rebate options for the commuter 38. For example, the transporting vehicle 26 may include a camera that captures an image of the commuter 38, as well as the weather determination software 36 that determines weather conditions outside of the transporting vehicle 26. The central computing device 22 may identify a characteristic of the commuter 38 from the captured image. For example, the central computing device 22 may determine that the commuter 38 does not appear to have an umbrella, and simultaneously determine that it is raining outside of the transporting vehicle 26. The central computing device 22 may then select a ride rebate option that includes an option to purchase an umbrella from a nearby retail store. In another example, the central computing device 22 may transmit an umbrella purchase offer from one or more retail stores via a website. In response to a purchase of the umbrella from the stores website, the fee charged to the commuter 38 may be reduced for this ride. It should be appreciated that the central computing device 22 may consider other personal characteristics of the commuter 38 and other environmental characteristics when selecting the ride rebate option to present to the commuter 38.

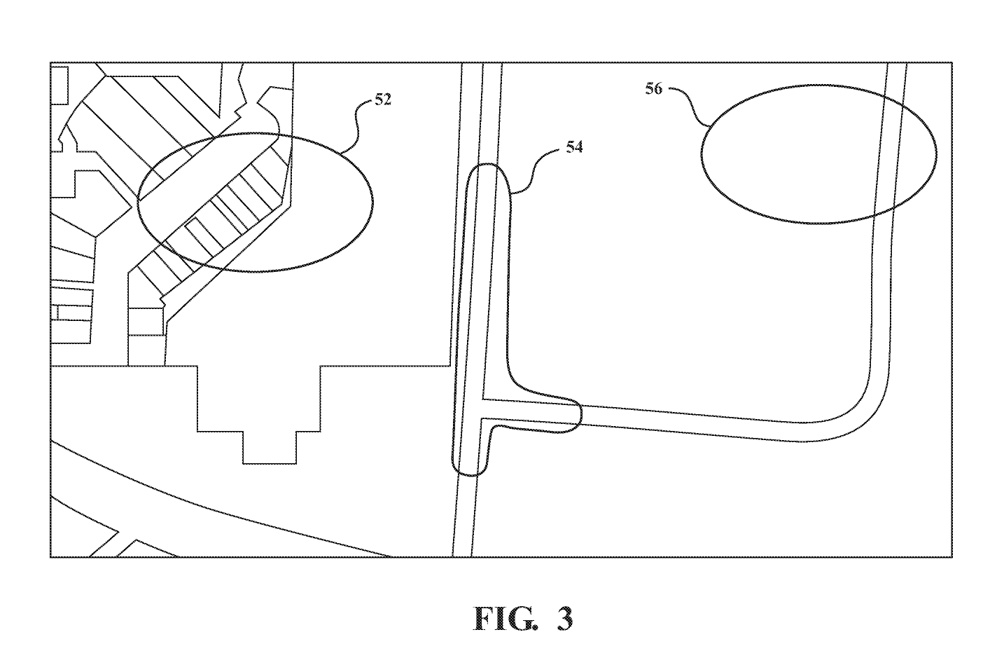

In another embodiment, selecting the ride rebate option may include communicating social data to the commuter 38. Referring to FIG. 3, the social data may include, but is not limited to, a destination 46 of other persons along the trip route 48, generally indicated by circled area 52 on the map shown in FIG. 3, current traffic congestion along the trip route 48, generally indicated by circled area 54 on the map shown in FIG. 3, or a current public event along the trip route 48, generally indicated by circled area 56 on the map shown in FIG. 3. The commuter 38 may then select an option category based on the social data presented to the commuter 38. For example, the central computing device 22 may communicate that traffic congestion along the travel route has caused a significant travel delay, and ask the commuter 38 if they would like to select a “Food” or “Retail” option while the traffic clears. It should be appreciated that the social data may vary from the exemplary embodiments described herein.

In another embodiment, the ride rebate option may be presented to the commuter 38 in the form of a survey. Such an option does not require that the third-party provider 40 be located near the travel route. The survey may include opinions of the commuter 38 regarding the third-party provider 40. Alternatively, the survey may include personal preferences of the commuter 38. The survey may also include queries regarding the commuter's 38 destination 46 and travel habits. The third-party provider 40 may use this data to develop marketing strategies for example. For example, the ride rebate option may include information regarding the frequency with which riders choose their particular facility.

The central computing device 22 may include and/or maintain a user profile of the commuter 38. The user profile may be stored in the memory of the central computing device 22. The central computing device 22 may select the ride rebate option based on the user profile of the commuter 38. For example, if the user profile indicates that the commuter 38 often travels to a coffee shop, then the central computing device 22 may identify a particular coffee shop as the third-party provider 40, and select a ride rebate option for that particular coffee shop. For example, the system 20 may present a route to the destination based on one or more available coffee shops in the area, based on the user's preferences. In response to the route being altered to arrive at the one or more of the coffee shops, the system may provide a ride rebate to the commuter 38, depending on whether the coffee shop will subsidize the cost to bring the commuter 38 to their store. The user profile of the commuter 38 may include, but is not limited to, ride rebate options previously executed by the commuter 38, destinations 46 previously selected by the commuter 38, or one or more personal preferences identified by the commuter 38. The central computing device 22 may update the user profile for the commuter 38 for each trip request.

As described above, the central computing device 22 identifies a third-party provider 40 and selects a ride rebate option that is presented to the commuter 38. The commuter 38 may choose or opt to execute the ride rebate option, or decline the ride rebate option. The step of determining if the commuter selects the ride rebate option or rejects the ride rebate option is generally indicated by box 108 in FIG. 4. If the commuter 38 declines the ride rebate option, and opts not to execute the ride rebate option, generally indicated at 110 in FIG. 4, then the central computing device 22 may transmit another, different ride rebate option to the commuter 38. If the commuter 38 opts to execute the ride rebate option, generally indicated at 112 in FIG. 4, and depending upon the specific form of the ride rebate option, the central computing device 22 may notify the third-party provider 40 that the commuter 38 has opted to execute the ride rebate option. The step of notifying the third-party provider 40 is generally indicated by box 114 in FIG. 4. For example, if the commuter 38 selects the “Food” category, and the central computing device 22 identifies a third-party provider 40 restaurant along the trip route 48 and presents the ride rebate option to the commuter 38 in the form of an option to purchase food from the third-party provider 40 or revise the trip route 48 to include a stop at the third-party restaurant, then the central computing device 22 may notify the third-party provider 40 restaurant of the commuter's 38 choice to execute the ride rebate option.

The third-party provider 40 may then confirm completion of the ride rebate option to the central computing device 22 of the transportation system 20. The step of confirming that the commuter 38 has completed the ride rebate option is generally indicated by box 116 in FIG. 4. For example, once the third-party provider 40 has been notified that the commuter 38 has opted to execute the ride rebate option, and the commuter 38 has completed the requirements of the ride rebate option, such as but not limited to, completing a purchase at the third-party provider 40, completing a survey for the third-party provider 40, etc., then the third-party provider 40 may notify the central computing device 22 that the commuter 38 has completed their obligations under the ride rebate option. In other examples, if the ride rebate option is presented in the form of a survey or other data inquiries of the commuter 38, then the central computing device 22 provides the results to the third-party provider 40, with a notification that the ride rebate option has been completed by the commuter 38. A notification may further be sent or otherwise communicated to the commuter 38 so that the commuter may verify the transaction.

Once the commuter 38 has completed their obligations under the ride rebate option, the central computing device 22 and the third-party provider 40 arrange a transfer of funds or credits therebetween. The step of transferring the payment amount from the third-party provider 40 to the transportation service is generally indicated by box 118 in FIG. 4. For example, the third-party provider 40 may transfer a payment amount to the transportation service upon confirmation by the third-party provider 40 that the commuter 38 has executed, i.e., completed, the ride rebate option. The payment amount may be dependent upon the specific ride rebate option executed by the commuter 38. For example, a survey may provide a pre-determined payment amount, whereas a purchase may provide a variable payment amount, dependent upon the value of the purchase. As such, different ride rebate options may provide a different payment amount. The specific payment amount for the different ride rebate options may be negotiated between the third-party provider 40 and the transportation service.

Once the transportation service has received the payment amount from the third-party provider 40 for the commuter 38 executing the ride rebate option, the transportation service may reduce its fee charged to the commuter 38. The step of reducing the fee charged to the commuter 38 is generally indicated by box 120 in FIG. 4. The fee may be reduced by all or a portion of the payment amount. In addition, the commuter 38 may opt to not reduce the fee for this trip, and may instead save the payment amount as a credit with the transportation service, to be used at a later time. Additionally, it is contemplated that the transportation service may keep a portion of the payment amount received by the third-party provider 40 to offset the cost of providing the ride rebate service. The ride rebate process described herein provides a convenient and simple process by which the commuter 38 may reduce or eliminate the cost of the trip provided by the transportation service. Additionally, the third-party provider 40 receives a commercial benefit by the commuter 38 completing the ride rebate option, while the transportation service still receives payment for providing the commuter 38 with transportation from their current location 44 to their desired destination 46.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of operating a transportation service, the method comprising:
receiving a trip request, with a central computing device at a service control location, from a commuter requesting transportation from a current location to a destination;
calculating a trip route between the current location and the destination with the central computing device;
transmitting a pick-up instruction from the central computing device to a transporting vehicle, wherein the pick-up instruction includes the trip route;
receiving the pick-up instruction with a mobile computing device of the transporting vehicle;
communicating a ride rebate option to the commuter, whereby the commuter may opt to execute the ride rebate option;
notifying a third-party provider when the commuter opts to execute the ride rebate option;
transferring a payment amount from the third-party provider to the transportation service upon confirmation by the third-party provider that the commuter has executed the ride rebate option; and
reducing a fee charged to the commuter by the transportation service by the payment amount transferred to the transportation service from the third-party provider.

2. The method set forth in claim 1, wherein the ride rebate option includes one of an option to purchase a product from the third-party provider, an option to provide data to the third-party provider, or an option to promote the third-party provider on a social media platform.

3. The method set forth in claim 2, wherein the option to provide data to the third-party provider includes the commuter providing details about the commuter's destination and travel habits to the third-party provider.

4. The method set forth in claim 1, further comprising identifying the third-party provider, with the central computing device, based on a distance between the third-party provider and the trip route.

5. The method set forth in claim 1, further comprising selecting the ride rebate option to be communicated to the commuter, with the central computing device.

6. The method set forth in claim 5, wherein selecting the ride rebate option is further defined as selecting the ride rebate option based on the trip route.

7. The method set forth in claim 5, wherein the central computing device includes a user profile of the commuter stored in a memory of the central computing device, and wherein selecting the ride rebate option is further defined as selecting the ride rebate option based on the user profile of the commuter.

8. The method set forth in claim 7, wherein the user profile of the commuter includes one of a previous ride rebate option previously executed by the commuter, a previous destination previously selected by the commuter, or one or more personal preferences identified by the commuter.

9. The method set forth in claim 5, further comprising sensing a personal characteristic of the commuter with a sensing device of the transporting vehicle, and communicating the sensed personal characteristic of the commuter to the central computing device.

10. The method set forth in claim 9, wherein selecting the ride rebate option is further defined as selecting the ride rebate option based on the sensed personal characteristic of the commuter.

11. The method set forth in claim 5, further comprising sensing an environmental characteristic adjacent the transporting vehicle with a sensing device of the transporting vehicle, and communicating the sensed environmental characteristic adjacent the transporting vehicle to the central computing device.

12. The method set forth in claim 11, wherein selecting the ride rebate option is further defined as selecting the ride rebate option based on the sensed environmental characteristic adjacent the transporting vehicle.

13. The method set forth in claim 5, wherein selecting the ride rebate option includes communicating social data to the commuter, wherein the social data includes a destination of other persons along the trip route, current traffic congestion along the trip route, or a current public event along the trip route.

14. The method set forth in claim 1, wherein the payment amount is dependent upon the ride rebate option executed by the commuter.

15. The method set forth in claim 14, wherein different ride rebate options provide a different payment amount.

16. The method set forth in claim 1, wherein the ride rebate option is communicated to the commuter through one of an input/output device of the mobile computing device, or a personal handheld device of the commuter.

17. A system for a transportation service, the system comprising:
a central computing device located at a service control location, the central computing device including a processor and a memory having a ride rebate algorithm stored thereon, wherein the processor of the central computing device is operable to execute the ride rebate algorithm to:
receive a trip request from a commuter requesting transportation from a current location to a destination;
calculate a trip route between the current location and the destination;
transmit a pick-up instruction to a transporting vehicle, wherein the pick-up instruction includes the trip route;
communicate a ride rebate option to the commuter, whereby the commuter may opt to execute the ride rebate option;
notify a third-party provider when the commuter has opted to execute the ride rebate option;
receive an electronic payment amount from the third-party provider upon confirmation from the third-party provider that the commuter has executed the ride rebate option; and
reduce a fee charged to the commuter by the transportation service by the payment amount received from the third-party provider.

18. The system set forth in claim 17, wherein the transporting vehicle includes a mobile computing device including a processor and a memory having the ride rebate algorithm stored thereon, wherein the processor of the mobile computing device is operable to execute the ride rebate algorithm to:
receive the pick-up instruction from the central computing device; and
transport the commuter from the current location of the commuter to the destination.

19. The system set forth in claim 17, wherein the central computing device is operable to execute the ride rebate algorithm to:
select a ride rebate option for the commuter based on a distance between the trip route and the third-party provider, a user profile of the commuter, a personal characteristic of the commuter, or an environmental characteristic adjacent the transporting vehicle along the trip route.

20. A system for a transportation service, the system comprising:
a transporting vehicle having a mobile computing device, the mobile computing device including a processor and a memory having a ride rebate algorithm stored thereon, wherein the processor of the mobile computing device is operable to execute the ride rebate algorithm to:
calculate a trip route between a current location and a destination;
communicate a ride rebate option to the commuter, whereby the commuter may opt to execute the ride rebate option;
notify a third-party provider when the commuter has opted to execute the ride rebate option;
receive an electronic payment amount from the third-party provider upon confirmation from the third-party provider that the commuter has executed the ride rebate option; and
reduce a fee charged to the commuter by the transportation service by the payment amount received from the third-party provider.
